(19) United States
(12) Patent Application Publication
(10) Pub. No.: US 2024/0162559 A1
(43) Pub. Date: May 16, 2024

(54) RECHARGEABLE ENERGY STORAGE SYSTEM HAVING A THERMAL RUNAWAY MITIGATION SYSTEM FOR A VEHICLE

(71) Applicant: GM Global Technology Operations LLC, Detroit, MI (US)

(72) Inventors: Jian Gao, Auburn Hills, MI (US); Xiaofeng Yang, Troy, MI (US); Ronald O. Grover, JR., Northville, MI (US); Wei Zeng, Oakland Township, MI (US)

(21) Appl. No.: 17/986,015

(22) Filed: Nov. 14, 2022

(51) Int. Cl. H01M 50/383; B60L 50/64; H01M 50/204; H01M 50/358

(52) U.S. Cl. CPC H01M 50/383; B60L 50/64; H01M 50/204; H01M 50/358; B05B 1/046; H01M 2200/00; H01M 2220/20

(57) ABSTRACT

A rechargeable energy storage system (RESS) including a thermal runaway propagation (TRP) mitigation system includes a housing including at least one outlet, a plurality of energy storage cells arranged in the housing, and at least one duct extending along the plurality of energy storage cells. The at least one duct is fluidically connected to the at least one outlet. A gas delivery system is arranged at the housing and includes a gas storage canister operable to deliver an amount of gas into the housing to purge combustible gases through the at least one outlet.

### INTRODUCTION

The subject disclosure relates to the art of vehicles and, more particularly, to a rechargeable energy storage system having a thermal runaway mitigation system for a vehicle.

Electric and hybrid electric vehicles include rechargeable energy storage systems (RESS). In a hybrid vehicle, the RESS is charged through operation of an engine operating on fossil fuels or through regenerative braking. Electric vehicles rely on an external energy supply to recharge the RESS. RESS typically includes multiple sealed cells that store electrical energy. In operation or during charging, one or more of the sealed cells may overheat. When a sealed cell overheats, undesirable gases may be produced. As such, RESS may include vents which provide an exit pathway for the undesirable gases.

If the RESS has a defect or is damaged, gases produced in a cell may become hot enough to ignite. The heat from one cell may affect adjacent cells creating additional damage. The damage may continue until the RESS is in a thermal runaway state. A thermal runaway may damage the entire RESS or, if left unchecked, the vehicle itself. Accordingly, it is desirable to provide a system to mitigate thermal runway of an RESS in a vehicle.

### SUMMARY

A rechargeable energy storage system (RESS) including a thermal runaway propagation (TRP) mitigation system includes a housing including at least one outlet, a plurality of energy storage cells arranged in the housing, and at least one duct extending along the plurality of energy storage cells. The at least one duct is fluidically connected to the at least one outlet. A gas delivery system is arranged at the housing and includes a gas storage canister operable to deliver an amount of gas into the housing to purge combustible gases through the at least one outlet.

In addition to one or more of the features described herein the gas storage canister includes a gas storage zone and a nozzle having a gas outlet fluidically connected to the gas storage zone.

In addition to one or more of the features described herein a valve element controls flow of gas from the gas storage zone to the nozzle.

In addition to one or more of the features described herein the nozzle comprises one of an axial flow nozzle and a radial flow nozzle that delivers the amount of gas into the housing.

In addition to one or more of the features described herein the axial flow nozzle comprises a dual direction axial flow nozzle including a first outlet positioned to deliver the amount of gas into the housing in a first direction and a second outlet positioned to deliver the amount of gas into the housing in a second direction that is opposite the first direction.

In addition to one or more of the features described herein the at least one duct includes a first duct extending through the housing in a first direction and a second duct extending through the housing in a second direction that is substantially perpendicular to the first direction, the second duct crossing the first duct at a first intersection.

In addition to one or more of the features described herein the nozzle includes a first nozzle arranged in the first duct and a second nozzle arranged at the first intersection.

In addition to one or more of the features described herein the first nozzle is a dual direction axial flow nozzle and the second nozzle is a radial flow nozzle.

In addition to one or more of the features described herein a third duct extends through the housing in the second direction, the third duct being spaced from the second duct and crossing the first duct at a second intersection, wherein a third nozzle is arranged at the second intersection.

In addition to one or more of the features described herein the amount of gas is one of an inert gas, an extinguishing agent, and combinations thereof.

A vehicle, in accordance with a non-limiting example, includes a body, an electric motor supported relative to the body, and a rechargeable energy storage system (RESS) including a thermal runaway propagation (TRP) mitigation system operatively connected to the electric motor, RESS including a housing including at least one outlet, a plurality of energy storage cells arranged in the housing, and at least one duct extending along the plurality of energy storage cells. The at least one duct is fluidically connected to the at least one outlet. A gas delivery system is arranged at the housing and includes a gas storage canister operable to deliver an amount of gas into the housing to purge combustible gases through the at least one outlet.

In addition to one or more of the features described herein the gas storage canister includes a gas storage zone and a nozzle having a gas outlet fluidically connected to the gas storage zone.

In addition to one or more of the features described herein a valve element controls flow of gas from the gas storage zone to the nozzle.

In addition to one or more of the features described herein the nozzle comprises one of an axial flow nozzle and a radial flow nozzle that delivers the amount of gas into the housing.

In addition to one or more of the features described herein the axial flow nozzle comprises a dual direction axial flow nozzle including a first outlet positioned to deliver the amount of gas into the housing in a first direction and a second outlet positioned to deliver the amount of gas into the housing in a second direction that is opposite the first direction.

In addition to one or more of the features described herein the at least one duct includes a first duct extending through the housing in a first direction and a second duct extending through the housing in a second direction that is substantially perpendicular to the first direction, the second duct crossing the first duct at a first intersection.

In addition to one or more of the features described herein the nozzle includes a first nozzle arranged in the first duct and a second nozzle arranged at the first intersection.

In addition to one or more of the features described herein the first nozzle is a dual direction axial flow nozzle and the second nozzle is a radial flow nozzle.

In addition to one or more of the features described herein a third duct extends through the housing in the second direction, the third duct being spaced from the second duct and crossing the first duct at a second intersection, wherein a third nozzle is arranged at the second intersection.

In addition to one or more of the features described herein the amount of gas is one of an inert gas, a extinguishing agent, and combinations thereof.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a left side view of a vehicle including a rechargeable energy storage system (RESS) having a thermal runaway mitigation system, in accordance with a non-limiting example;

FIG. 2 is a perspective view of the RESS having the thermal runaway mitigation system, in accordance with a non-limiting example;

FIG. 3 is a perspective view of a gas storage canister and gas delivery system of the thermal runaway mitigation system, in accordance with a non-limiting example;

FIG. 4 is a gas delivery nozzle of the gas delivery system for the thermal runaway mitigation system, in accordance with a non-limiting example; and

FIG. 5 is a gas delivery nozzle of the gas delivery system for the thermal runaway mitigation system, in accordance with another non-limiting example.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

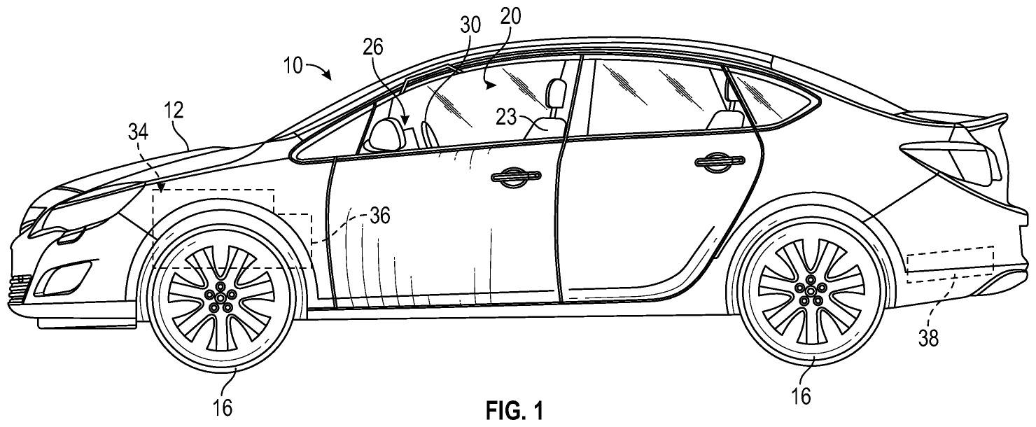

A vehicle, in accordance with a non-limiting example, is indicated generally at 10 in FIG. 1. Vehicle 10 includes a body 12 supported on a plurality of wheels 16. In a non-limiting example, two of the plurality of wheels 16 are steerable. That is, changing a position of two of the plurality of wheels 16 relative to body 12 will cause vehicle 10 to change direction. Body 12 defines, in part, a passenger compartment 20 having seats 23 positioned behind a dashboard 26. A steering control 30 is arranged between seats 23 and dashboard 26. Steering control 30 is operated to control orientation of the steerable wheel(s).

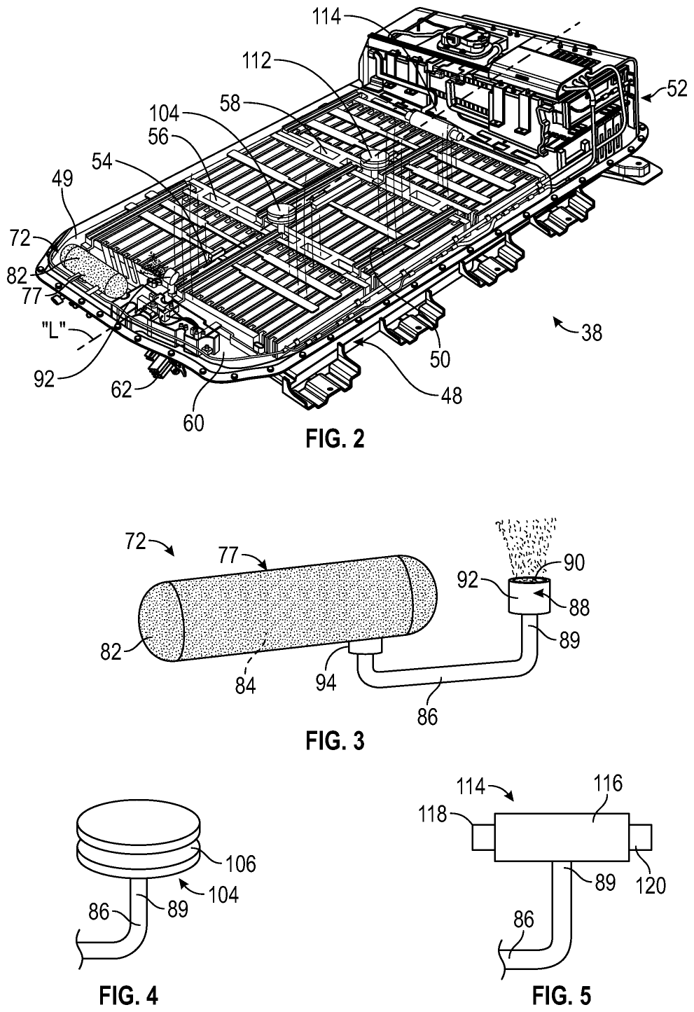

Vehicle 10 includes an electric motor 34 connected to a transmission 36 that provides power to one or more of the plurality of wheels 16. A rechargeable energy storage system (RESS) 38 provides power to electric motor 34. Referring to FIG. 2, RESS 38 includes a housing 48 having an interior portion 49 within which are arranged a plurality of energy storage cells, one of which is indicated at 50. Each of the plurality of energy storage cells 50 is connected to a battery monitoring system 52 arranged in housing 48. RESS 38 includes a first or primary duct 54 that extends along a longitudinal axis “L” of housing 46 below the plurality of energy storage cells, a second duct 56 that intersects first duct 54, and a third duct 58 that is spaced from second duct 56 and intersects first duct 54. Second and third ducts 56 and 58 intersect first duct 54 at a substantially perpendicular angle. A perimeter duct 60 may extend entirely about energy storage cells 50. Housing 46 includes an outlet 62 that is fluidically connected to interior portion 49.

In accordance with a non-limiting example, RESS 38 includes a thermal runaway propagation (TRP) mitigation system 72. As shown in FIG. 3, TRP mitigation system 72 includes a gas delivery system 77 having a gas storage canister 82. Gas storage canister 82 includes a gas storage zone 84 and a conduit 86. A nozzle 88 is connected to conduit 86. Nozzle 88 includes an inlet 89 and an outlet 90. Nozzle 88 in accordance with a non-limiting example, is shown in the form of an axial flow nozzle 92 that is positioned at a terminal end of first duct 54. The term “axal flow” should be understood to describe a nozzle that directs a flow along a single axis. In the present case, the single axis is substantially perpendicular to outlet 62 in order to enhance gas dispersion within interior portion 49.

In a non-limiting example, the gas is introduced into interior portion 49 of housing 48 in several directions including in a direction opposite to that of outlet 62 as will be detailed herein. In this manner, the gas flows toward a rear wall (not separately labeled) of housing 48 and disperses throughout interior portion 49 to ensure that all undesirable gas is purged through outlet 62. Further, by locating gas storage canister 82 within housing 48 packaging efficiency is increased. That is, there is no need to take up other valuable space to locate a source of gas. Moreover, the efficacy of the inert gas is not temperature dependent in accordance with a non-limiting example. That is, the gas need not be at room temperature in order to effectively purge undesirable gases from interior portion 49 and thus gas storage canister 82 may reside in housing 48 adjacent to energy storage cells 50.

In a non-limiting example, gas delivery system 77 may include a valve element 94 that controls a flow of gas from gas storage zone 84, through conduit 86, and out from nozzle 88 into interior portion 49 of housing 48. The gas passing into interior portion 49 forces undesirable gases that may be in housing 48 through outlet 62 to reduce the likelihood of a thermal runway condition in RESS 38. In a non-limiting example, the gas introduced into housing 48 may be an inert gas such as nitrogen, an extinguishing agent, or a combination thereof. The particular type of gas in gas storage zone 84 may vary and could be application specific, (i.e., tailored to the particular chemical make up of energy storage cells 50). Reference will now follow to FIG. 4 in describing a radial flow nozzle 104 in accordance with another non-limiting example. Radial flow nozzle 104 may be used in place of axial flow nozzle 92 or, as shown in FIG. 2, as a supplemental gas delivery mechanism arranged at an intersection of second duct 56 and first duct 54. Radial flow nozzle 104 includes a circular slot outlet 106. Circular slot outlet 106 is arranged to deliver gas from gas storage zone 84 in a 360° circle in housing 48. As also shown in FIG. 2, a second radial flow nozzle 112 may be arranged at an intersection of third duct 58 and first duct 54.

TRP mitigation system 72 may include a dual direction axial flow nozzle 114 arranged at a terminal end of first duct 54. Referring to FIG. 5, dual direction axial flow nozzle 114 may be used in combination with one or more radial flow nozzles 88 and 112 to enhance the purging of undesirable gases from housing 48. Dual direction axial flow nozzle 114 includes a nozzle head 116 having a first outlet 118 directed in a first direction and a second outlet 120 directed in a second direction. The second direction may be 180° opposite the first direction. The dual direction axial flow from dual direction axial flow nozzle 114 taken together with one or more radial flow nozzles 104 and 112, and axial flow nozzle 88 will overpower any gases in interior portion 49 causing a purge through outlet 62.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A rechargeable energy storage system (RESS) including a thermal runaway propagation (TRP) mitigation system comprising:
a housing including at least one outlet;
a plurality of energy storage cells arranged in the housing;
at least one duct extending along the plurality of energy storage cells, the at least one duct being fluidically connected to the at least one outlet; and
a gas delivery system is arranged at the housing, the gas delivery system including a gas storage canister operable to deliver an amount of gas into the housing to purge combustible gases through the at least one outlet.

2. The RESS including the TRP mitigation system according to claim 1, wherein the gas storage canister includes a gas storage zone and a nozzle having a gas outlet fluidically connected to the gas storage zone.

3. The RESS including the TRP mitigation system according to claim 2, further comprising a valve element controlling flow of gas from the gas storage zone to the nozzle.

4. The RESS including the TRP mitigation system according to claim 2, wherein the nozzle comprises one of an axial flow nozzle and a radial flow nozzle that delivers the amount of gas into the housing.

5. The RESS including the TRP mitigation system according to claim 4, wherein the axial flow nozzle comprises a dual direction axial flow nozzle including a first outlet positioned to deliver the amount of gas into the housing in a first direction and a second outlet positioned to deliver the amount of gas into the housing in a second direction that is opposite the first direction.

6. The RESS including the TRP mitigation system according to claim 2, wherein the at least one duct includes a first duct extending through the housing in a first direction and a second duct extending through the housing in a second direction that is substantially perpendicular to the first direction, the second duct crossing the first duct at a first intersection.

7. The RESS including the TRP mitigation system according to claim 6, wherein the nozzle includes a first nozzle arranged in the first duct and a second nozzle arranged at the first intersection.

8. The RESS including the TRP mitigation system according to claim 7, wherein the first nozzle is a dual direction axial flow nozzle and the second nozzle is a radial flow nozzle.

9. The RESS including the TRP mitigation system according to claim 8, further comprising a third duct extending through the housing in the second direction, the third duct being spaced from the second duct and crossing the first duct at a second intersection, wherein a third nozzle is arranged at the second intersection.

10. The RESS including the TRP mitigation system according to claim 1, wherein the amount of gas is one of an inert gas, an extinguishing agent, and combinations thereof.

11. A vehicle comprising:
a body;
an electric motor supported relative to the body; and
a rechargeable energy storage system (RESS) including a thermal runaway propagation (TRP) mitigation system operatively connected to the electric motor, the RESS comprising:
a housing including at least one outlet;
a plurality of energy storage cells arranged in the housing;
at least one duct extending along the plurality of energy storage cells, the at least one duct being fluidically connected to the at least one outlet; and
a gas delivery system is arranged at the housing, the gas delivery system including a gas storage canister operable to deliver an amount of gas into the housing to purge combustible gases through the at least one outlet.

12. The vehicle according to claim 11, wherein the gas storage canister includes a gas storage zone and a nozzle having a gas outlet fluidically connected to the gas storage zone.

13. The vehicle according to claim 12, further comprising a valve element controlling flow of gas from the gas storage zone to the nozzle.

14. The vehicle according to claim 12, wherein the nozzle comprises one of an axial flow nozzle and a radial flow nozzle that delivers the amount of gas into the housing.

15. The vehicle according to claim 14, wherein the axial flow nozzle comprises a dual direction axial flow nozzle including a first outlet positioned to deliver the amount of gas into the housing in a first direction and a second outlet positioned to deliver the amount of gas into the housing in a second direction that is opposite the first direction.

16. The vehicle according to claim 12, wherein the at least one duct includes a first duct extending through the housing in a first direction and a second duct extending through the housing in a second direction that is substantially perpendicular to the first direction, the second duct crossing the first duct at a first intersection.

17. The vehicle according to claim 16, wherein the nozzle includes a first nozzle arranged in the first duct and a second nozzle arranged at the first intersection.

18. The vehicle according to claim 17, wherein the first nozzle is a dual direction axial flow nozzle and the second nozzle is a radial flow nozzle.

19. The vehicle according to claim 18, further comprising a third duct extending through the housing in the second direction, the third duct being spaced from the second duct and crossing the first duct at a second intersection, wherein a third nozzle is arranged at the second intersection.

20. The vehicle according to claim 11, wherein the amount of gas is one of an inert gas, a extinguishing agent, and combinations thereof.
